(19) United States
(12) Patent Application Publication
(10) Pub. No.: US 2025/0059374 A1
(43) Pub. Date: Feb. 20, 2025

(54) USE OF BISAMIDE COMPOUNDS TO IMPROVE THE AGEING RESISTANCE OF BITUMEN

(71) Applicants: TOTALENERGIES ONETECH, Courbevoie (FR); SORBONNE UNIVERSITE, Paris (FR); CENTRE NATIONAL DE LA RECHERCHE SCIENTIFIQUE, Paris (FR)

(72) Inventors: Julie PREVOST, Courbevoie (FR); Laurent BOUTEILLER, Paris (FR); Sandrine PENSEC, Paris (FR); Océane FORT, Courbevoie (FR)

(21) Appl. No.: 18/720,548

(22) PCT Filed: Dec. 12, 2022
(86) PCT No.: PCT/EP2022/085422

§ 371 Date: Jun. 14, 2024

(30) Foreign Application Priority Data
Dec. 17, 2021 (FR) FR2113817

(51) Int. Cl. C08L 95/00; C08K 5/20; C10C 3/02

(52) U.S. Cl. CPC C08L 95/00; C08K 5/20; C10C 3/026; C08L 2201/08; C08L 2555/70

(57) ABSTRACT

The present invention relates to the use of bisamide compounds to improve the ageing resistance and/or increase the service life and/or delay the appearance of signs of ageing of a bituminous composition. The invention also relates to a method for improving the ageing resistance and/or increasing the service life and/or delaying the appearance of signs of ageing of a bituminous composition.

The present invention belongs to the field of bitumens and relates to the increase in the longevity of bitumen and the products derived therefrom. The invention relates to the use of bisamide compounds for improving the aging resistance of bitumen. The invention further relates to a method for improving the resistance to aging of a bituminous composition.

### PRIOR ART

Bitumen or bituminous binder is the main hydrocarbon binder used in the fields of road construction and civil engineering. Bitumen is also used to seal various supports. The quality of a bitumen, in particular for road applications, is based on the resistance of bitumen to aging, understood as resistance to changes of the basic parameters thereof.

Bitumen is a material that changes over time and undergoes an aging process which depends on traffic load and/or climatic influences.

In general, the aging of bitumen takes place in two stages, first in the short term, during the production of the bituminous binder or mix, storage and laying at high temperatures cause degradation due to the oxidation and volatilization of the volatile fractions contained in the bitumen, then, over the long term, during the lifetime of the pavement and/or of the building and/or of the support to which the bitumen is applied.

The main factors affecting bitumen aging are the oxidation induced by oxygen from the air, temperature variations, exposure to humidity and exposure to ultraviolet rays.

Oxidation is the main cause of bitumen aging, often referred to as oxidative aging. Such type of aging involves irreversible chemical reactions between the bitumen components and atmospheric oxygen. Research has shown that oxidative aging of bitumen occurs through a chain reaction mechanism that results in an increase in the number of polar and reactive functional groups, such as e.g. carbonyl or sulfoxide functions, the increase in condensation products as well as the aromaticity of bitumen and the decrease in the content of saturated compounds.

A rise in temperature is also an important factor that catalyzes oxidation reactions and accelerates the aging of bitumen.

Another factor that aggravates the aging of bitumen is ultraviolet radiation. Ultraviolet rays attack mainly the upper layer of the road, leading to the weakening thereof. A heat transfer can result therefrom, from the upper layer to the base layer, which accelerates oxidation reactions within the bituminous layer.

Thereby, the aging process leads to the loss of various physical-chemical properties of bitumen, e.g. viscoelastic properties, impermeability to water, or adhesive strength, which generally makes bituminous materials harder and more brittle, thereby increasing the risk of pavement failure. Aging manifests as such in the form of cracks, brittleness, loss of elasticity and loss of resistance. Potholes and undesirable asperities appear, the edges of the road surface crumble. The road surface can deteriorate over time to the point of impeding driving and possibly reducing driving safety. Also, in the field of building construction, the aging of bitumen leads to a loss of mechanical performance which results in sealing defects, water infiltration, surface discontinuities such as cracks, wall cracks, broken tiles.

Therefore, the development of an effective additive is important to improve the performance of bitumen and prolong the service life of pavements, buildings and supports to which bitumen is applied as a sealing material, such as roofs, terraces, balconies, facades, foundations, etc.

With the above in mind, application WO2017/027096 proposes to incorporate sterols into bitumens.

The applicant has discovered that the use of bisamide compounds corresponding to general formula (I) as defined hereinbelow is surprisingly effective in improving the resistance of bitumen to aging.

Bisamide compounds have been described in patent applications EP2106423, WO2018/115730 and WO2020/120408 to improve the rheological properties of bitumen, more particularly the viscosity and hardness characteristics, during the production and the use of bitumen.

None of these documents mentions nor suggests a use of bisamide compounds to improve the aging resistance of bitumen.

US2019/184678 describes bituminous compositions for coating shingles comprising ethylene bis stearamide or ethylene bis oleamide as an additive improving the resistance to aging caused by UV radiation, heat and moisture.

CA1260653 describes bituminous compositions for coating shingles containing ethylene bis stearamide as an additive improving resistance to weathering.

CN106349723 describes the use of bisamide compounds in bituminous compositions to improve the bitumen softening temperature while reducing hot viscosity. The addition of the bisamide compound serves to fluidize the bitumen more quickly at high temperature. Said document does not describe the use of the bisamide compound to improve the aging resistance of bitumen.

CN107286684 describes that the association of a bisamide compound with inorganic nanomaterials improves the resistance to aging of bituminous compositions.

The applicant has discovered that the addition, to a bituminous composition, of particular bisamide compounds according to the invention makes it possible to produce a bitumen which is more resistant to aging phenomena, more particularly oxidative aging, and the mechanical properties of which, in particular elastic properties, degrade more slowly, thereby extending the service life thereof, the conditions of severity of use being the same.

The resulting bitumen, having improved aging resistance, can be used e.g. in the manufacture of roadways and road maintenance products, in the construction of buildings and in the manufacture of watertight roof membranes, by serving to reduce the frequency of renewal and/or of renovation of bituminous compositions in the different applications.

### SUMMARY OF THE INVENTION

The invention relates to the use of at least one bisamide compound with the formula (I)

R_{A}—X—R_{C}—X′—R_{B} (I)
R_{A} and R_{B} being a linear, cyclic or branched, saturated or unsaturated hydrocarbon chain comprising 1 to 36 carbon atoms, and optionally comprising heteroatoms such as N, O, S,
R_{C} being a linear, cyclic or branched, saturated or unsaturated hydrocarbon chain comprising 3 to 18 carbon atoms, substituted if appropriate, and optionally comprising heteroatoms, such as N, O, S,
X and X′ representing an amide function —NH—CO— or —CO—NH,

to improve the resistance to aging and/or increase the service life and/or delay the appearance of signs of aging of a bituminous composition.

According to a preferred embodiment, the compound corresponds to the formula (IA)

R_{A}—CONH—R_{C}—NHCO—R_{B} (IA).

In formula (I) and/or formula (IA), R_{C} represents a hydrocarbon chain comprising 3 to 18 carbon atoms.

Preferably, R_{C} represents a linear and saturated hydrocarbon chain.

Again preferably, R_{C} is chosen from the groups —C₄H₈—, —C₆H₁₂—, —C₈H₁₆—, AND —C₁₀H₂₀—

Advantageously, in formula (I) and/or formula (IA), R_{A} and R_{B}, which may be identical or different, represent a hydrocarbon chain comprising from 4 to 22 carbon atoms.

Preferably, R_{A} and R_{B}, which are identical or different, represent a linear hydrocarbon chain.

Advantageously, the bisamide compound of general formula (I) is used in a concentration of 0.1 to 30% by weight relative to the total weight of the bituminous composition.

Advantageously, the signs of aging are chosen from cracks, detachments, ruts, collapses, potholes, chipping, crumbling, blistering and/or crazing.

Advantageously, the bisamide compounds with the formula (I) are used to improve the resistance of the bituminous composition to oxidative and/or thermal aging.

Advantageously, the bisamide compounds with the formula (I) are used to improve the resistance of the bituminous composition to aging caused by the presence of oxygen and/or by exposure to ultraviolet radiation and/or by thermal variation and/or by exposure to moisture and/or exposure to weathering.

According to one embodiment, the bisamide compounds with the formula (I) are used in the manufacture of roadways, to reduce the frequency of renewal and/or of renovation of roadways.

According to another embodiment, the bisamide compounds with the formula (I) are used in the construction of buildings, to reduce the frequency of renewal and/or of renovation of buildings.

Advantageously, the bituminous composition is a bituminous mix.

Advantageously, the bisamide compounds with the formula (I) are used to reduce and/or minimize and/or delay and/or attenuate the degradation of at least one mechanical property, preferably the ring and ball temperature and/or the elastic recovery, of the bituminous composition.

The invention further relates to a method for improving the resistance to aging and/or increasing the service life and/or delaying the appearance of signs of aging of a bituminous composition, said method comprising at least the following steps:
i. preparation of a bituminous composition comprising at least one bisamide compound with the formula (I) as defined hereinabove and in more detail hereinbelow,
ii. aging of the bituminous composition,
iii. measurement of resistance to aging.

Advantageously, the method comprises at least the following steps:
i. preparation of a bituminous composition comprising at least one bisamide compound with the formula (I), and, optionally other additives,
ii. subjecting the bituminous composition to an aging process caused by the presence of oxygen and/or by exposure to ultraviolet radiation and/or by thermal variations and/or by exposure to moisture and/or by exposure to weathering,
iii. measurement of one or a plurality of parameters selected from ring and ball softening temperature, non-recoverable creep compliance, and/or elastic recovery percentage to evaluate resistance to aging.

Advantageously, the method of the invention further comprises a step of applying the bituminous composition to a roadway and/or to a surface of a building after step (i) of preparation of the bituminous composition and before step (iii) of measurement of the resistance to aging.

### DETAILED DESCRIPTION

The expression “consists essentially of” followed by one or a plurality of characteristics means that, in addition to the explicitly listed components or steps, components or steps that do not significantly alter the properties and characteristics of the invention can be included in the method or the material of the invention.

The expression “comprised between X and Y” includes the bounds, unless explicitly stated otherwise. The expression thus means that the target interval comprises the values X, Y, and all values from X to Y.

The different embodiments, variants, preferences and advantages described for each of the subject matters of the invention apply to all the subject matters of the invention and can be taken separately or in combination.

The aim of the invention is to provide an additive for bitumen which prolongs the service-life of bitumen.

According to a first aspect, the present invention relates to the use of at least one bisamide compound with the formula (I), as defined hereinabove and in detail hereinbelow, to improve the resistance to aging and/or to increase the service life and/or to delay the appearance of signs of aging of a bituminous composition.

According to a second aspect, the invention relates to a method for improving the resistance to aging and/or increasing the service life and/or delaying the appearance of signs of aging of a bituminous composition, the method comprising the preparation of a bituminous composition comprising at least one bisamide compound with the formula (I) as defined hereinabove and in detail below, the aging of the bituminous composition and then the measurement of the resistance to aging.

As defined by the invention, the terms “bitumen”, “bituminous composition” and “bituminous binder” are used, in an equivalent manner and independently of each other.

The term “bitumen”, “bituminous composition” or “bituminous binder” means any bitumen-containing composition consisting of one or a plurality of base bitumens and optionally comprising one or a plurality of chemical additives, where said compositions can be used in a road application, in particular mixed with granulates, or in an application in the construction field, in particular for the waterproofing of constructions.

The term “resistance to aging” means the property of a bitumen to resist the modification of the physical-chemical characteristics thereof, in particular the rheological and mechanical characteristics thereof, when subject to an aging process whatever the origin of the aging.

In particular, the invention improves the resistance of bitumen to aging resulting from chemical modifications caused by the presence of oxygen and/or by exposure to ultraviolet radiation and/or by thermal variations and/or by exposure to moisture and/or by exposure to weathering.

The term “improving the resistance to aging of a bituminous composition” means reducing and/or delaying and/or slowing down and/or avoiding and/or preventing and/or stopping and/or suppressing the aging of the bituminous composition.

The ability of a bituminous composition to resist aging can be evaluated by measuring one or a plurality of physical-chemical characteristics of the bituminous composition prior to aging and then repeating the same measurements after aging. The comparison of the physical-chemical properties of a bituminous composition before and after aging provides indicators of the resistance of the bituminous composition to aging.

By “increasing the service life of a bituminous composition” is meant first of all to increase the duration during which the bituminous composition can be maintained in use after being applied. The latter property makes it possible to reduce the frequency of renewal and/or of renovation of roadways, and/or to reduce the frequency of renovation of buildings.

By “increasing the service life of a bituminous composition” is also meant to increase the duration during which the composition can be stored and/or transported, while preserving good application properties. The latter property makes it possible to store and/or transport a bituminous composition over longer periods of time.

In the applications of bituminous compositions, a better resistance to aging is observed by a later or less significant appearance of the signs of aging.

The signs of aging of a bituminous composition are in particular the appearance of cracks and/or detachment and/or ruts and/or collapses and/or potholes and/or chipping and/or crumbling and/or blistering and/or crazing. Such signs may appear both on roadways in the case where the bituminous composition is used in road applications and on the surface of buildings in the case where the bituminous composition is used to provide waterproofing, insulation, protection and waterproofing to surfaces such as roofs, terraces, balconies, facades, foundations, etc.

The use of the bisamide compounds with the formula (I) as described hereinabove and in detail hereinbelow serves to delay, preferably avoid, the appearance of the signs of aging as defined hereinabove and consequently, to reduce the frequency of renewal and/or renovation of roadways in road applications and to reduce the frequency of renewal and/or of renovation of buildings in the field of civil engineering.

In order to reproduce experimentally, the physical-chemical changes that are observed in the structure of bitumen during the years of service, different aging simulation tests can be implemented such as the Rolling Thin Film Oven Test (RTFOT) to simulate short-term aging and accelerated long-term aging process (using PAV (Pressure Aging Vessel) equipment) to simulate long-term aging.

The accelerated aging process using a PAV equipment is used to simulate, in the laboratory, the long-term aging of bitumens. The protocol was developed to simulate the hardening of bitumen during aging after several years of field service, e.g. from 5 to 10 years. The test consists of a treatment of bituminous binders by means of air under pressure and with a high temperature, to cause accelerated oxidation, simulating natural aging. The procedure consists of placing 50 grams of a bituminous composition in a stainless-steel cup. A plurality of cups are then placed in an enclosure heated to 100° C. under a dry air pressure of 2.1 MPa, for a specified length of time. A detailed protocol of the accelerated aging process applied within the framework of the present invention is described in the experimental part.

Advantageously, the invention relates to an improvement in at least one physical-chemical characteristic of the bitumen which is observed after an accelerated aging of the bituminous composition using PAV equipment over a period of at least 20 hours, preferably at least 48 hours, else preferably at least 72 hours.

In particular, the invention relates to an improvement in at least one physical-chemical characteristic of bitumen which is observed after application and after aging of the bituminous composition under service conditions.

Advantageously, the invention makes it possible to avoid and/or delay the appearance and/or decrease the extent of the signs of aging of bitumen after application and after aging of the bituminous composition under service conditions.

The physical-chemical characteristics measured to evaluate aging may be penetrability, ring and ball temperature (RBT), ductility, elastic response and sensitivity to permanent deformation, viscosity, chemical structure of bitumen, etc. The list of characteristics is not limited to the above, it should be understood that other physical-chemical characteristics of bitumen, known to a person skilled in the art, can also be measured to evaluate the resistance to aging.

The variation in the physical-chemical characteristics of the bitumen before the aging test and after the aging test expresses the ability of the bitumen to resist aging, more particularly oxidative aging. More specifically, depending on each characteristic, the evaluation of resistance to aging can be based on the rate of change before the aging test and after the aging test as will be become clear hereinafter.

The rate of change of the measured characteristic can be determined by the following formula

$$Rate of change = \vert \frac{{V}_{f} - {V}_{i}}{{V}_{i}} \times 100 \vert$$

where Vᵢ represents the initial value of the characteristic measured before aging and V_{f} represents the final value of the characteristic measured after aging.

Penetrability is a measure called “needle penetrability” which is carried out by means of a standardized test NF EN 1426 at 25° C. (P25). Penetrability represents the measurement of penetration into a sample of bitumen or of another type of binder, after a time of 5 seconds, of a needle the weight of which along with the support thereof is 100 g. Penetrability is expressed in tenths of a millimeter (dmm or 1/10 mm). In an aging process, penetrability tends to decrease over time.

The ring and ball temperature (RBT) is a measurement carried out by means of a standardized test NF EN 1427. The ring and ball softening temperature corresponds to the temperature at which a steel ball of standard diameter, after passing through the material to be tested (glued in a ring), reaches the bottom of a standardized vessel filled with a liquid which is gradually heated, and wherein the apparatus has been immersed. In an aging process, the ring and ball temperature tends to increase with time.

Advantageously, within the framework of the present invention, it is considered that a bituminous composition is resistant to aging if the rate of change of the ring and ball temperature is lower than same of the same bituminous composition not comprising bisamide compounds, provided that the rate of change of the ring and ball temperature is measured after an accelerated aging treatment of at least 20 hours using PAV equipment.

The elastic response and sensitivity to permanent deformation of bitumen are parameters that can be evaluated by a creep-recovery test under repeated stresses (Multiple stress Creep Recovery MSCR).

The MSCR test consists of a series of creep-recovery tests at increasing stress levels performed on a single sample at 60° C. 10 creep/recovery cycles are repeated at each stress threshold. During each cycle, the stress is applied for 1 s and then the material recovers for 9 s. The stress levels 00 applied in the following order and without rest time are: 25, 50, 100, 200, 400, 800, 1,600, 3,200, 6,400, 12,800 and 25,600 Pa.

The goal of the MSCR test is to evaluate the resistance of bitumen to permanent deformation. The permanent deformation is defined by the criteria of non-recoverable compliance Jnr and of the percentage of elastic recovery εr. Both criteria are calculated from the experimental data.

The non-recoverable compliance Jnr in kPa-1 measures the permanent deformation normalized by the stress

$$Jnr = \frac{{y}_{a c c}}{τ}$$

where
γ_{acc} corresponds to the unrecoverable deformation after 9 s of recovery (or permanent or accumulated) and
τ corresponds to the stress applied during the creep-recovery cycle.

The percentage of elastic recovery εr in % characterizes the percentage of recovered deformation with respect to the total deformation.

$$ε r = \frac{{γ}_{r}}{{γ}_{tot}}$$

where:
γₜₒₜ corresponds to the total deformation after 1 s of creep. γₜₒₜ=γᵣ+γ_{acc},
γᵣ corresponds to the recoverable deformation after 9 s of recovery.

Advantageously, within the framework of the present invention, it is considered that a bituminous composition comprising a bisamide compound is resistant to aging if, for the same applied stress, the rate of change in elastic recovery εr is lower compared to that of the same bituminous composition without bisamide compounds, with the proviso that the rate of change in elastic recovery is measured after an accelerated aging treatment of at least 20 hours using PAV equipment.

Advantageously, in the context of the present invention, it is considered that a bituminous composition comprising a bisamide compound is resistant to aging if, for the same constraint applied, the rate of change in the non-recoverable creep compliance Jnr is lower than the rate of change in the non-recoverable creep compliance of the same bituminous composition not comprising bisamide compounds, provided that the rate of change in non-recoverable compliance is measured after accelerated aging treatment of at least 25 hours using PAV equipment.

Advantageously, the use of the bisamide compounds with the formula (I) as described hereinabove and in detail below makes it possible to reduce and/or minimize and/or delay and/or attenuate the degradation of at least one mechanical property, in particular the ring and ball temperature and/or the elastic recovery, of a bituminous composition.

The term “mechanical property” preferably means the ring and ball temperature, the elastic recovery and/or the permanent deformation.

### Use of Bisamide Compounds for Improving the Resistance to Aging of Bituminous Compositions

### The Bisamide Compound

The bisamide compound(s) used in the framework of the invention are chosen amongst compounds with the formula (I):

R_{A}—X—R_{c}—X′—R_{b} (I)

in which:
the moieties R_{A} and R_{B}, either identical or different, represent a linear, cyclic or branched, saturated or unsaturated hydrocarbon chain, comprising from 1 to 36 carbon atoms, possibly substituted and possibly comprising heteroatoms such as N, O, S,
the moiety R_{C} represents a linear, cyclic or branched, saturated or unsaturated hydrocarbon chain, comprising from 1 to 22 carbon atoms, possibly substituted and possibly comprising heteroatoms such as N, O, S,
X and X′ independently represent an amide functional group —NH—CO— or —CO—NH—

Preferably, the compounds of formula (I) are chosen amongst compounds of formula (IA) or compounds of formula (IB) defined below:

R_{A}—CONH—R_{C}—NHCO—R_{B} (IA)

R_{A}—CONH—R_{C}—NHCO—R_{B} (IB)

Advantageously R_{C} represents a hydrocarbon chain comprising from 3 to 18 carbon atoms, preferably from 3 to 14 carbon atoms, preferably from 4 to 12 carbon atoms, preferentially from 4 to 10 carbon atoms.

Advantageously R_{C} represents a linear and saturated hydrocarbon chain.

In a preferred embodiment of the invention, R_{C} is chosen amongst the moieties —C₄H₈—, —C₆H₁₂—, —C₈H₁₆—, and —C₁₀H₂₀—.

Advantageously, R_{A} and R_{B}, either identical or different, represent a hydrocarbon chain comprising from 4 to 22 carbon atoms, preferably from 8 to 20 carbon atoms more preferentially from 10 to 20 carbon atoms.

Examples of R_{A} and R_{B} moieties include undecyl, dodecyl, tridecyl, tetradecyl, hexadecyl, heptadecyl, octadecyl, oleyl, eicosyl, etc.

According to a preferred embodiment of the invention, R_{A} and R_{B}, either identical or different, represent a linear hydrocarbon chain.

According to a preferred embodiment of the invention, R_{A} and R_{B}, either identical or different, represent a saturated hydrocarbon chain or a hydrocarbon chain comprising one or two alkenyl bonds. According to a still preferred embodiment, R_{A} and R_{B}, either identical or different, represent a saturated hydrocarbon chain or a hydrocarbon chain comprising an alkenyl bond.

Preferably, R_{A} and R_{B} are identical.

Preferably, in the formulae (I), (IA) and (IB), the sum of the carbon atoms composing R_{A}, R_{B} and R_{C} is comprised between 12 and 60, even more preferentially between 20 and 50.

In a preferred embodiment, the bisamide compounds used within the framework of the invention are chosen from compounds with the formula (IA).

Particularly preferred bisamide compounds are, e.g., compounds with the formula (I), preferentially compounds with the formula (IA), wherein
R_{C} is a —C₄H₈— moiety and R_{A} and R_{B} are each a heptadecyl moiety, preferably n-heptadecyl,
R_{C} is a —C₆H₁₂— moiety and Ra and RB are each an undecyl moiety, preferably n-undecyl, or
R_{C} is a —C₆H₁₂— moiety and Ra and RB each represent an n-heptadec-8-enyl moiety.

The bisamide compound with the general formula (I) can be prepared by conventional synthetic methods known to a person skilled in the art, such as e.g. by reaction between a diamine and two carboxylic acids or by reaction between a dicarboxylic acid and two monoamines. Certain bisamide compounds corresponding to general formula (I) are commercially available.

Advantageously, the bisamide compound or compounds with general formula (I), preferably with the formula (IA), are used in the bituminous composition in a concentration ranging from 0.1 to 30% by weight, preferably from 0.5 to 20%, preferably from 0.5 to 10%, more preferably from 1 to 5% by weight relative to the total weight of the bituminous composition.

Advantageously, according to the invention, only the bisamide compound as described hereinabove is responsible for the effect of improving the resistance to aging of the bitumen. In other words, the improvement in resistance to aging is observed when the bisamide compound is used alone and does not result from a synergistic effect between the bisamide compound according to the invention and another compound which may be included in the bituminous composition.

### The Bituminous Composition

The bituminous compositions which can be used according to the invention may contain one or a plurality of bitumens coming from different origins.

Amongst bitumens which can be used according to the invention, first of all can be cited, bitumens of natural origin, bitumens contained in deposits of natural bitumen, of natural asphalt or tar sands, and bitumens coming from the refining of crude oil, can be mentioned first. The bitumens which can be used according to the invention are advantageously chosen from bitumens coming from the refining of crude oil or coming from bituminous sands.

The bitumens may be chosen from bitumens or mixtures of bitumens originating from the refining of crude oil, more particularly bitumens containing asphaltenes or pitches. The bitumens can be obtained by conventional methods for the manufacture of bitumens in refineries, more particularly by direct distillation and/or vacuum distillation of petroleum. Such bitumens may be, if appropriate, viscoducted and/or deasphalted and/or ground in air. It is common practice to carry out vacuum distillation of atmospheric residues coming from the atmospheric distillation of crude oil. Such manufacturing method thus corresponds to the succession of atmospheric distillation and vacuum distillation, the feedstock feeding the vacuum distillation corresponding to the residues of the atmospheric distillation. Such vacuum residues from the vacuum distillation tower can also be used as bitumens. It is also common to inject air into a feedstock usually composed of distillates and heavy products from the vacuum distillation of atmospheric residues coming from petroleum distillation. Such method serves to obtain a blown, semi-blown or oxidized or ground in air or partially ground in air base. The different bitumens or base bitumens obtained by the refining processes can be combined with one another so as to obtain the best technical compromise.

The bitumens may also be bitumens coming from recycling.

The bitumens can be hard grade bitumens or soft grade bitumens.

Advantageously, bitumen is chosen from bitumens of natural origin, bitumens coming from bituminous sands; bitumens coming from crude oil refining such as atmospheric distillation residues, vacuum distillation residues, visbreaking residues, blown residues and mixtures thereof; and the combinations thereof or from synthetic bitumens otherwise known as clear binders.

Preferably, the bitumen used in the invention has a needle penetrability measured at 25 C according to the standard EN 1426 of 5 to 330 1/10 mm, preferably of 20 to 220 1/10 mm.

Preferably, the bitumen used in the invention has a ring and ball softening temperature (RBT) according to the standard EN 1427, of 50 to 175° C.

The bituminous compositions may also comprise other additives different from the bisamide compounds according to the invention. The other additives may be chosen, without being limited to, from polymers, more particularly elastomers, olefinic polymer adjuvants, vulcanizing agents and/or cross-linking agents, anti-caking agents and/or viscosifying agents.

As an example, among the elastomer additives, mention may be made of copolymers SB, SBS, SIS, SBS*, SBR, EPDM. Such elastomers can also be cross-linked according to any known process, e.g. with sulfur. Mention may also be made of elastomers produced from styrene monomers and butadiene monomers permitting cross-linking without any cross-linking agent as described in documents WO2007/058994, WO2008/137394 and, by the applicant, in patent application WO11/013073.

Among the olefinic polymer adjuvants, mention may be made of ethylene/glycidyl (meth)acrylate copolymers, ethylene/monomer A/monomer B terpolymers, monomer A being chosen from vinyl acetate and C₁ to C₆ alkyl acrylates or methacrylates, monomer B being chosen from glycidyl acrylate and glycidyl methacrylate, and mixtures of such copolymers.

Olefin polymer adjuvants are described in detail in applications WO2020/187580 and WO2021/019141.

Among the anti-caking compounds, mention may be made of talc, fines generally with a diameter of less than 125 μm; sand; cement; carbon; wood residues such as lignin; conifer needle powders and conifer cone powders; glass powder, alumina; silica; silica derivatives such as silicates; pyrogenic silica; silicon hydroxides and silicon oxides; plastic powder; and mixtures thereof. Anti-caking compounds are described in detail in application WO2018/046840.

Preferably, the bituminous composition according to the invention comprises from 0.05% to 15% by weight of one or a plurality of the additives such as the additives mentioned in detail hereinabove, more preferentially from 0.1% to 10% by weight, else more preferentially from 0.5% to 6% by weight, relative to the total weight of the bituminous composition.

The bituminous composition used according to the invention may be in any form. Advantageously, the bituminous composition according to the invention is solid when cold and in a divided form.

The term “cold solid composition” means a bitumen exhibiting a solid appearance at ambient temperature whatever the transport and/or storage conditions, more particularly bitumen which preserves the solid appearance thereof and which does not flow at ambient temperature under its own weight or when subjected to pressure forces arising from transport and/or storage conditions.

“A divided form” means a composition in the form of units distinct from each other, such as granules or blocks.

The divided form may be obtained by shaping the bituminous composition according to any known method, e.g. according to the manufacturing method described in the documents U.S. Pat. No. 3,026,568, WO 2009/153324 or WO 2012/168380. In particular, it is possible to use the methods described in WO2018/104660.

Preferably, the bituminous composition used according to the invention consists essentially of one or a plurality of bitumens and of one or a plurality of compounds with the formula (I) as defined hereinabove.

According to an advantageous variant, the bituminous compositions comprise, preferably essentially consist of:
70% to 99.9% by weight of bitumen and
from 0.1% to 30% by weight of one or a plurality of compounds with the formula (I) as defined hereinabove.

Preferably, the bituminous compositions comprise, and preferably essentially consist of
80% to 99.5% by weight of bitumen and
from 0.5% to 20% by weight of one or a plurality of compounds with the formula (I) as defined hereinabove.

According to another advantageous variant, preferably, the bituminous compositions preferably comprise, preferably essentially consist of
75% to 99.45% by weight of bitumen and
from 0.5% to 10% by weight of one or a plurality of compounds with the formula (I) as defined hereinabove,
from 0.05% to 15% by weight of one or a plurality of additives different from the bisamide compound with the formula (I).

According to another aspect, the invention relates to the provision of a bituminous mix having an improved resistance to aging, comprising granulates and at least one bituminous composition as described hereinabove and comprising at least one bisamide compound with the formula (I), preferably a bisamide compound with the formula (IA).

The term “granulates” refers to all mineral grains having a dimension of less than 125 mm such as fines, ultra-fine sands, sands, gravel sand mix, gravel, ballasts, rip-rap and a mixture of such materials.

### Method for Improving the Aging Resistance of a Bituminous Composition

According to a second aspect of the invention, the subject of the present invention is a method for improving the resistance to aging and/or increasing the service life and/or delaying the appearance of signs of aging of a bituminous composition, said method comprising at least the following steps
i. preparation of a bituminous composition comprising at least one bisamide compound with the formula (I), and, optionally other additives,
ii. aging of the bituminous composition,
iii. measurement of resistance to aging.

Advantageously, the method comprises at least the following steps
i. preparation of a bituminous composition comprising at least one bisamide compound with the formula (I), and, optionally other additives,
ii. subjecting the bituminous composition to an aging process caused by the presence of oxygen and/or by exposure to ultraviolet radiation and/or by thermal variations and/or by exposure to moisture and/or by exposure to weathering,
iii. measurement of one or a plurality of parameters selected from ring and ball softening temperature, non-recoverable creep compliance, and/or elastic recovery percentage to evaluate resistance to aging.

The first step (i) of the method is a step of preparation of a bituminous composition comprising one or a plurality of bisamide compounds as defined hereinabove. Such step can be carried out according to conventional techniques known to a person skilled in the art. For example, said step may comprise (a) the use of at least one bitumen by heating same to a temperature between 11° and 180° C., (b) the addition of at least one bisamide compound with the formula (I) to the bitumen and, optionally other additives, and (c) stirring the bituminous composition until the mixture is homogenized.

For example, in one embodiment, the preparation method for preparing bituminous compositions according to the invention comprises the following steps:
a) a bitumen is inserted into a container equipped with mixing means, and the bitumen is brought to a temperature between 7° and 220° C., preferably between 9° and 180° C., preferably between 11° and 180° C.,
b) at least one bisamide compound with the formula (I) and, optionally, additives are fed in,
c) the bituminous composition from step b) is heated to a temperature comprised between 7° and 220° C., preferably between 9° and 180° C., preferably between 11° and 180° C., under stirring, until a homogeneous bituminous composition is obtained,
d) optionally, the bituminous composition resulting from step c) is shaped, and more particularly put into divided form.

Preferably, in sub-step b), the bisamide compound with the formula (I) is added to the bitumen in a concentration ranging from 0.1 to 30% by weight, preferably from 0.5 to 20%, in a preferred way from 0.5 to 10%, in a more preferred way from 1 to 5% by weight relative to the total mass of the bituminous composition.

In sub-step (b), the order of addition of the bisamide compound(s) with the formula (I) and the other additives is not important.

The different embodiments, variants, preferences and advantages described hereinabove for the bisamide compounds with the formula (I) and the uses thereof according to the invention, as well as for bitumen, apply to step (i) of the method.

A person skilled in the art is able to adapt the mixing parameters such as the heating temperature, the mixing time, the speed of stirring, etc.

According to a preferred embodiment of the invention, the method for improving the resistance to aging and/or increasing the service life and/or delaying the appearance of signs of aging of a bituminous composition comprises a step (i′) of application of the bituminous composition after the step of preparation of the bituminous composition according to the invention (i) and before the aging step (ii).

The term “application of the bituminous composition” means the implementation by the so-called “hot”, “warm” or so-called “cold” techniques, well known to the person skilled in the art of bituminous composition, to manufacture coatings such as in the field of road construction, in the building industry or to provide sealing to supports such as roofs.

The aging stage (ii) of the bituminous composition may comprise short-term aging and/or long-term aging.

According to one embodiment of the invention, the aging step (ii) of the bituminous composition is a short-term aging step.

According to a preferred embodiment of the invention, the aging step (ii) of the bituminous composition comprises a short-term aging sub-step followed by a long-term aging sub-step.

The step (ii) may be an aging carried out on a laboratory scale, in particular by the accelerated aging protocols described in detail hereinabove, or an aging during service, i.e. after the application of the bitumen, in particular on a roadway or on a building.

The aging resistance measurement step (iii) is preferably carried out by measuring the rate of change of the value of one or a plurality of characteristic parameters of bitumens after the aging process, either accelerated or not accelerated, with respect to the value of said parameter before aging.

The measured parameter or parameters are preferably chosen from the ring and ball softening temperature, the non-recoverable creep compliance, and/or the elastic recovery percentage.

The methods for measuring each parameter are the methods known to a person skilled in the art and more particularly the methods as defined hereinabove in the present invention.

According to another aspect, the invention relates to a method for improving the resistance to aging and/or increasing the service life and/or delaying the appearance of signs of aging of a bituminous mix comprising at least the following steps:
heating granulates to a temperature ranging from 100° C. to 180° C., preferably from 120° C. to 160° C.,
mixing the granulates with the bituminous composition as described hereinabove and comprising at least one bisamide compound with the formula (I) in a vat such as a mixer or a mixing drum,
recovering the bituminous mix,
where appropriate, applying the bituminous mix over a support,
letting the bituminous mix age,
measuring the resistance to aging of the bituminous mix.

### DESCRIPTION OF FIGURES

FIG. 1 represents the curves of variation of the elastic recovery εr (in %, y-axis) as a function of the applied stress (in kPa, x-axis) of different bituminous compositions before aging (curves in solid lines) and after aging according to an accelerated aging protocol using a PAV for 25 h (dashed line curves) and for 48 h (dotted line curves).

### EXAMPLES

The invention is illustrated by the following examples, but not limited to.

In the examples, the parts and percentages are expressed by weight unless otherwise indicated.

### 1—Materials and Methods

Bitumen: grade 35/50 base bitumen having a P25 penetrability of 46 1/10 mm and an RBT of 53.2° C. and commercially available from TotalEnergies under the brand name AZALT®.
Additive 1 (according to the invention) bisamide with the formula (IA) wherein R_{A}=R_{B}=C17 linear and saturated and R_{C}=—(CH₂)₄—.
Additive 2 (according to the invention) bisamide with the formula (IA) wherein R_{A}=R_{B}=C11 linear and saturated and RC=—(CH₂)₆—.
Additive 3 (according to the invention) bisamide with the formula (IA) wherein R_{A}=R_{B}=C17 is linear and contains ethylenic unsaturation between carbon atoms 8 and 9 and R_{C}=(CH₂)₆—
Additive 4 (comparative) 2′,3-bis [(3-[3,5-di-tert-butyl-4 hydroxyphenyl]propionyl)] propionohydrazide commercially available under the brand name Irganox MD 1024®.
Additive 5 (comparative) N,N′-ethylenediol (stearamide) commercially available under the brand name Crodawax®.

### 2—Methods for Determining the Properties of Bituminous Compositions

The mechanical characteristics of the bituminous compositions to which reference is made in the present examples are measured according to the methods indicated in Table 1.

TABLE 1
Mechanical properties and measurement methods

| | | | Measurement |
|---|---|---|---|
| Property | Abbreviation | Unit | standard |
| Needle | P₂₅ | 1/10 mm | NF EN 1426 |
| penetrability at | | | |
| 25° C. | | | |
| Ring and Ball | RBT | ° C. | NF EN 1427 |
| Softening | | | |
| Temperature | | | |
| Accelerated aging | PAV | — | NF EN 14769 |
| protocol | | | |
| Elastic recovery | εr | % | NF EN 13398 |

### 3—Preparation of Bituminous Compositions

The additive bituminous compositions are prepared by feeding in the base bitumen and the additive into a reactor with stirring and at 170° C. in the proportions reported in Table 2 hereinbelow. The mixtures are stirred and heated at 160° C. for approximately 1 hours.

Compositions C1 to C3 are according to the invention and compositions C4 and C5 are comparative. Composition C0 is a control composition which does not comprise any additive. The proportions of the additives in the different compositions are chosen so as to obtain bituminous compositions having the same RBT value at around 100° C.

TABLE 2
Prepared bituminous compositions

| Composition | C0 | C1 | C2 | C3 | C4 | C5 |
|---|---|---|---|---|---|---|
| Bitumen base | 100% | 98% | 98% | 94% | 99.1% | 97% |
| Additive 1 | | 2% | | | | |
| Additive 2 | | | 2% | | | |
| Additive 3 | | | | 6% | | |
| Additive 4 | | | | | 0.9% | |
| Additive 5 | | | | | | 3% |

### 4—Protocol for the Aging of Bituminous Compositions

The prepared bituminous compositions underwent accelerated aging using PAV equipment such as Prentex 9500 according to the following protocol: Each composition was heated at 160° C. for 40 minutes in order to be able to be transferred into metal cups (50 g+/−0.5 g of composition). The cups were then placed in an aging container at 21 bars of air pressure and at a temperature of 100° C. for a defined length of time, more particularly for 25 h and 48 h. At the end of the allotted aging time, the cups were recovered and placed in an oven heated to 170° C. After 30 minutes, all cups were transferred to a single container. The container was then placed in a vacuum oven (vacuum of 15 kPa) for degassing at 177° C. for a period of 30 minutes. Finally, the product was recovered.

### 5—Results

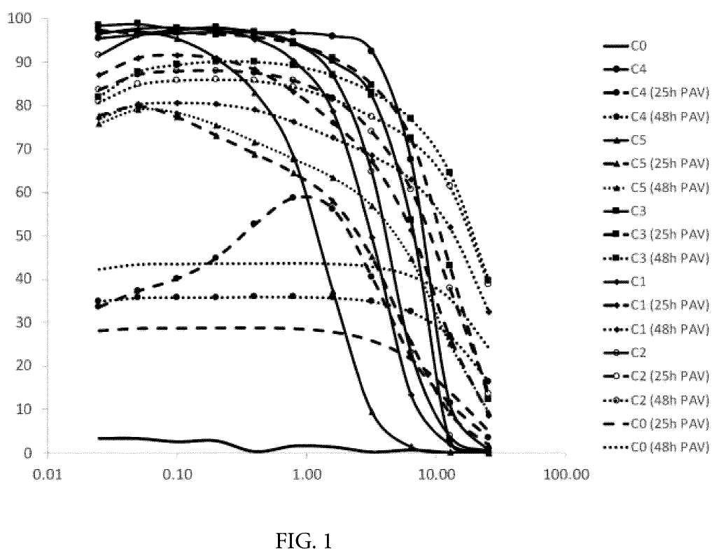

FIG. 1 shows the curves of variation of the elastic recovery (in %) of the compositions C0 to C5 before and after aging as a function of different stresses. The curves show that the bituminous compositions supplemented with the bisamide compounds according to the invention better recover their resistance compared to the bitumen with no additives (C0), after accelerated aging protocol using a PAV equipment at 25 h and at 48 h. The bituminous compositions with added bisamide compounds with the formula (I) exhibit very little sign of aging. The ring and ball temperature and the recovery under stress conditions at 0.1 kPa and at 3.2 kPa were measured according to the protocols described hereinabove on the different bituminous compositions prepared before aging and after aging using a PAV equipment after 25 hours, then after 48 hours. The results are shown in Tables 3, 4 and 5.

TABLE 3
Properties of bituminous compositions before aging

| | RBT (° C.) | εr at 0.1 kPa (%) | εr at 3.2 kPa (%) |
|---|---|---|---|
| C0 | 53.2 | 2.5 | 0.1 |
| C1 | 105 | 97.8 | 48.2 |
| C2 | 99 | 97.3 | 64.6 |
| C3 | 94 | 97.7 | 82.3 |
| C4 | 102.6 | 96.6 | 92.5 |
| C5 | 98.5 | 95.4 | 9.5 |

TABLE 4
Properties of bituminous compositions following an accelerated
aging protocol using PAV equipment at 25 h.

| | | | | Rate of | | Rate of |
|---|---|---|---|---|---|---|
| | | | | change of | | change of |
| | | Rate of | εr at | εr at | εr at | εr at |
| | RBT | change | 0.1 kPa | 0.1 kPa | 3.2 kPa | 3.2 kPa |
| | (° C.) | of RBT | (%) | (%) | (%) | (%) |
| C0 | 67.8 | 27.4 | 28.6 | 1044 | 25.7 | 25,600 |
| C1 | 103.5 | 1.4 | 91.6 | 7.1 | 64.6 | 34.0 |
| C2 | 99.5 | 0.5 | 87.8 | 9.7 | 73.9 | 14.4 |
| C3 | 91.0 | 3.2 | 96.6 | 1.1 | 84.7 | 2.9 |
| C4 | 65.4 | 36.2 | 40.0 | 58.6 | 39.8 | 56.9 |
| C5 | 95.5 | 3.0 | 77.3 | 19.0 | 45.0 | 373.7 |

TABLE 5
Properties of bituminous compositions following an accelerated
aging protocol using PAV equipment at 48 h.

| | | | | Rate of | | Rate of |
|---|---|---|---|---|---|---|
| | | | | change of | | change of |
| | | Rate of | εr at | εr at | εr at | εr at |
| | RBT | change | 0.1 kPa | 0.1 kPa | 3.2 kPa | 3.2 kPa |
| | (° C.) | of RBT | (%) | (%) | (%) | (%) |
| C0 | 72.6 | 36.4 | 43.3 | 1632 | 42.7 | 42,600 |
| C1 | 95 | 9.5 | 80.6 | 17.6 | 64.6 | 34.0 |
| C2 | 88 | 11.1 | 57.8 | 11.8 | 77.4 | 19.8 |
| C3 | 90.5 | 3.7 | 89.3 | 8.6 | 83.0 | 0.85 |
| C4 | 71 | 30.8 | 35.7 | 63.0 | 34.8 | 62.4 |
| C5 | 95.0 | 3.5 | 87.3 | 18.0 | 56.9 | 489.9 |

It is found that the rates of variation of the ring and ball temperature (RBT) and of the elastic recovery of the bituminous compositions comprising the bisamide additives with the formula (I) according to the invention (compositions C1 to C3) are significantly lower than the corresponding rates of change in the case of a composition containing the additive Irganox (composition C4) or a bitumen composition without additives.

The compositions C1 to C3 comprising the bisamide additives with the formula (I) according to the invention exhibit lower rates of change of recovery under stress conditions at 0.1 kPa and at 3.2 kPa after 25 and 48 h compared with the composition C5 comprising a bisamide additive as described in prior art US2019/184678.

The results demonstrate that the bituminous compositions to which the bisamide compounds according to the invention were added, exhibit a moderate and favorable change of the aging indicators in an accelerated aging test between 25 h and 48 h, unlike the comparative compositions.

1.-16. (canceled)

17. A method for improving the resistance to aging and/or increasing the service life and/or delaying the appearance of signs of aging of a bituminous composition, the method comprising incorporating into the bituminous composition at least one bisamide compound of formula (I)
R_{A}—X—R_{C}—X′—R_{B} (I)
wherein
R_{A} and R_{B} are independently selected from the group consisting of linear, cyclic or branched, saturated or unsaturated hydrocarbon chains comprising 1 to 36 carbon atoms, and optionally comprising heteroatoms,
R_{C} is a linear, cyclic or branched, saturated or unsaturated hydrocarbon chain comprising 3 to 18 carbon atoms, optionally substituted, and optionally comprising heteroatoms,
X and X′ represent an amide function —NH—CO— or —CO—NH.

18. The method according to claim 1, wherein the bisamide compound has the formula (IA)
R_{A}—CONH—R_{C}—NHCO—R_{B} (IA)

19. The method according to claim 1, wherein R_{C} represents a linear and saturated hydrocarbon chain.

20. The method according to claim 1, wherein R_{C} is:
selected from the group consisting of —C₄H₈—, —C₆H₁₂—, —C₈H₁₆—, and —C₁₀H₂₀—.

21. The method according to claim 1, wherein R_{A} and R_{B}, either identical or different, represent a hydrocarbon chain comprising from 4 to 22 carbon atoms.

22. The method according to claim 1, wherein R_{A} and R_{B}, either identical or different, represent a linear hydrocarbon chain.

23. The method according to claim 1, wherein the bisamide compound of formula (I) is used in a concentration from 0.1 to 30% by weight with respect to the total weight of the bituminous composition.

24. The method according to claim 1, wherein the bituminous composition further additives different from the bisamide compound of formula (I).

25. The method according to claim 1, wherein the bituminous composition is solid when cold and in a divided form.

26. The method according to claim 1, wherein the signs of aging are selected from the groups consisting of cracks, detachments, ruts, collapses, potholes, chipping, crumbling, blistering and crazing.

27. The method according to claim 1, for improving the resistance of the bituminous composition to oxidative and/or thermal aging.

28. The method according to claim 1, wherein the aging is caused by the presence of oxygen and/or by exposure to ultraviolet radiation and/or by thermal variation and/or by exposure to moisture and/or by exposure to weathering.

29. The method according to claim 1, for reducing the frequency of renewal and/or of renovation of the roadways.

30. The method according to claim 1, for reducing the frequency of renewal and/or of renovation of buildings.

31. The method according to claim 1, wherein the bituminous composition is a bituminous mix.

32. The method according to claim 1, for reducing and/or minimizing and/or delaying and/or attenuating the degradation of at least one mechanical property of the bituminous composition.

33. The method according to claim 32, wherein the mechanical property is selected from the group consisting of the ring and ball softening temperature, the elastic recovery and the permanent deformation.

34. The method according to claim 1, wherein the method comprises at least the following steps:
i. preparation of a bituminous composition comprising at least one bisamide compound of formula (I) as defined in claim 1,
ii. subjecting the bituminous composition to an aging process caused by the presence of oxygen and/or by exposure to ultraviolet radiation and/or by thermal variations and/or by exposure to moisture and/or by exposure to weathering,
iii. measurement of one or a plurality of parameters selected from the group consisting of ring and ball softening temperature, non-recoverable creep compliance, and elastic recovery percentage to evaluate resistance to aging.

35. The method according to claim 34, further comprising a step of applying the bituminous composition to a roadway and/or a surface of a building after the step (i) of preparation of the bituminous composition and before step (iii).
